(19) United States
(12) Patent Application Publication
(10) Pub. No.: US 2025/0206662 A1
(43) Pub. Date: Jun. 26, 2025

(54) ARTIFICIAL MARBLE HAVING SAME TEXTURE AS NATURAL STONE, AND MANUFACTURING METHOD THEREFOR

(71) Applicant: LX HAUSYS, LTD., Seoul (KR)

(72) Inventors: Yechan KIM, Seoul (KR); Bonho KOO, Seoul (KR); Donghee KIM, Seoul (KR); Hongkwan CHO, Seoul (KR)

(73) Assignee: LX HAUSYS, LTD., Seoul (KR)

(21) Appl. No.: 18/848,383

(22) PCT Filed: Mar. 28, 2023
(86) PCT No.: PCT/KR2023/004095

§ 371 Date: Sep. 18, 2024

(30) Foreign Application Priority Data
Apr. 14, 2022 (KR) 10-2022-0046504
Aug. 26, 2022 (KR) 10-2022-0107423

(51) Int. Cl. C04B 14/06; B28B 11/08; C04B 14/36; C04B 26/18; C04B 41/72

(52) U.S. Cl. CPC C04B 14/06; B28B 11/0809; C04B 14/36; C04B 26/18; C04B 41/72

(57) ABSTRACT

The present invention relates to an artificial marble including a first composition including a first binder resin, a first inorganic particle, and first inorganic powder; and a second composition including a second binder resin, a second inorganic particle, and second inorganic powder, wherein at least one surface of the artificial marble includes at least two regions among a region provided with the first composition, a region provided with the second composition, and a region where the first composition and the second composition are mixed, and at least one of a surface roughness, a scratch resistance, and a thickness in each of the at least two regions is different, and also relates to a method for manufacturing the artificial marble.

### TECHNICAL FIELD

This application claims priority to and the benefit of Korean Patent Application No. 10-2022-0046504 filed in the Korean Intellectual Property Office on Apr. 14, 2022, and Korean Patent Application No. 10-2022-0107423 filed in the Korean Intellectual Property Office on Aug. 26, 2022, the entire contents of which are incorporated herein by reference.

The present invention relates to an artificial marble with a texture similar to natural stone and a method for manufacturing the same.

### BACKGROUND ART

Artificial marble is an artificial composite, which has a pattern and a texture of natural stone implemented by mixing natural stone powder, minerals and the like with a base, for example, a resin such as an acrylic resin, an unsaturated polyester resin, and an epoxy resin, or cement and adding additives such as a pigment. Representative examples include acrylic artificial marble, polyester-based artificial marble, epoxy-based artificial marble, and engineered stone-based artificial marble.

Engineered stone, also called E-stone, is an artificial marble composed mainly of quartz and natural stone powder. Demand for engineered stone is gradually increasing for interior floors, wall decorations, kitchen worktops, and the like, and accordingly, there is a need for a technique capable of implementing various designs.

In particular, in the recent interior design markets, interests in designs with natural textures that are more similar to the appearance of natural stone are gradually increasing.

### CITATION LIST

Patent Literature: Korean Patent No. 10-1270415

### DETAILED DESCRIPTION OF THE INVENTION

### Technical Problem

The present invention is to provide an artificial marble with a texture similar to natural stone and a method for manufacturing the same.

### Technical Solution

An exemplary embodiment of the present invention provides an artificial marble including a first composition including a first binder resin, a first inorganic particle, and first inorganic powder; and a second composition including a second binder resin, a second inorganic particle, and second inorganic powder, wherein at least one surface of the artificial marble includes at least two regions among a region provided with the first composition, a region provided with the second composition, and a region where the first composition and the second composition are mixed, and at least one of a surface roughness, a scratch resistance, and a thickness in each of the at least two regions is different.

Another exemplary embodiment of the present invention provides a method for manufacturing an artificial marble, the method including preparing a first composition including a first binder resin, a first inorganic particle, and first inorganic powder, and a second composition including a second binder resin, a second inorganic particle, and second inorganic powder; curing the first composition and the second composition; and finishing surfaces of the cured first and second compositions by a leather finish method, wherein at least one surface of the artificial marble includes at least two regions among a region provided with the first composition, a region provided with the second composition, and a region where the first composition and the second composition are mixed, and at least one of a surface roughness, a scratch resistance, and a thickness in each of the at least two regions is different.

### Advantageous Effects

The artificial marble of the present invention includes the first composition and the second composition that are individually mixed, respectively, and includes a region provided with the first composition, has characteristics that at least one of the surface roughness, scratch resistance, and thickness in at least two regions among the region provided with the first composition, the region provided with the second composition, and the region where the first composition and the second composition are mixed is different, and accordingly, can realize a unique texture of a material such as natural stone in a variety of ways, as compared to existing artificial marble with uniform texture. For example, materials with different hardness are included in the region including the first composition and the region including the second composition, so that when a surface finishing treatment such as a leather finish method is performed, an artificial marble having a surface finished state, for example, a surface roughness, a scratch resistance, and/or a thickness, which is different depending on the hardness of the materials, is provided.

### BRIEF DESCRIPTION OF DRAWINGS

FIGS. 1 to 3 show photographs of surfaces of artificial marbles prepared in Examples 1 to 3, respectively.

### BEST MODE

Hereinafter, exemplary embodiments of the present invention will be described in detail. However, the following descriptions are provided to exemplify the above exemplary embodiments, not to limit the scope of the present invention.

It should be understood that the terms or words used throughout the specification should not be construed as being limited to their ordinary or dictionary meanings, but construed as having meanings and concepts consistent with the technical idea of the present invention, based on the principle that an inventor may properly define the concepts of the words or terms to best explain the invention.

The terms used in the present specification are merely used to describe various exemplary embodiments of the present invention but are not intended to limit the present invention. The singular forms “a”, “an” and “the” are intended to include plural forms as well, unless the context clearly indicates otherwise.

In the present specification, it should be understood that terms such as “include”, “comprise” or “have” are used to describe the presence of a specific component, and do not exclude the presence or possibility of addition of other components.

In the present specification, the expression “existing on” a specific component is intended to express “existing on one side” of a specific component, and is not intended to limit a upper-lower relationship, and is not also limited to being in physical contact with the component but means that another member may be additionally provided between the components.

In the present specification, “pattern” is an expression distinct from an entire surface layer, and unlike the entire surface layer in which a specific material occupies an entire volume of one layer, means that a specific material occupies only a part of a volume of one layer, and a part of the corresponding layer is an empty space or is filled with another material.

In the present specification, a vein pattern means a pattern resembling a vein or a tree branch, and means a pattern that is continued to have a certain length or longer. In the present specification, the vein pattern is not limited to a straight line or a specific curved line. In the present specification, the vein pattern may also be referred to as a stripe pattern.

In the present specification, “base” refers to a base part other than a pattern in an artificial marble.

In the present specification, “region where a first composition and a second composition are mixed” refers to a region on a surface of an artificial marble where the first composition and the second composition are mixed, and refers to a region where a region consisting only of the first composition and a region consisting of only the second composition have a width of less than 2 cm.

Hereinafter, exemplary embodiments of the present invention will be described in detail.

An artificial marble according to an exemplary embodiment of the present invention includes a first composition including a first binder resin, first inorganic particles, and first inorganic powder; and a second composition comprising a second binder resin, second inorganic particle and second inorganic powder, wherein at least one surface of the artificial marble includes at least two regions among a region provided with the first composition, a region provided with the second composition, and a region where the first composition and the second composition are mixed, and at least one of a surface roughness, a scratch resistance, and a thickness in each of the at least two regions is different.

The artificial marble according to the exemplary embodiment includes the first composition and the second composition, which are separate compositions, at least one surface of the artificial marble includes at least two regions among the region provided with the first composition, the region provided with the second composition, and the region where the first composition and the second composition are mixed, and at least one of a surface roughness, a scratch resistance, and a thickness in each of the at least two regions is different. As an example, in a case where the hardness of the material is different in the region provided with the first composition and the region provided with the second composition, when a surface finishing treatment such as a leather finish method is performed on the artificial marble, the artificial marble may have a surface finished state such as surface roughness and/or scratch resistance, which is different in each region depending on the difference in hardness of the materials in the respective regions, and a thickness may vary depending on a degree of polishing in each region. As a result, various textures like natural stone can be realized.

According to an exemplary embodiment, a degree of mixing of the components included in the first composition and a degree of mixing of the components included in the second composition are each higher than a degree of mixing of the first composition and the second composition. For example, the components included in each of the first composition and the second composition may be present in a relatively uniformly mixed state. Here, the uniformly mixed state does not mean only a completely uniform state, but means that the respective components are properly dispersed to an extent acceptable in the field of artificial marble. For example, the uniformly mixed state means that the components included in the first or second composition are mixed within a range in which the components can be mixed using a uniformizing mixer.

On the other hand, the degree to which the first composition and the second composition are mixed with each other is relatively low. For example, the first composition and the second composition may be in a state in which they are non-uniformly mixed with each other. Here, the non-uniformly mixed state means that the components of each of the first composition and the second composition are not completely mixed with each other and at least some of the components are present while maintaining their respective compositions. In other words, when the first composition and the second composition are non-uniformly mixed, at least a part or all of the first composition and at least a part or all of the second composition are present in the artificial marble without being mixed with components of the other composition. Accordingly, a boundary may be formed between the region where the first composition is present and the region where the second composition is present. For example, after mixing the first composition and the second composition using separate mixers, the first composition and the second composition mixed respectively are mixed non-uniformly.

The non-uniform mixing may be performed using, for example, a ring mixer, and the degree of mixing may be adjusted by adjusting a speed, a number of rotations, and the like of the ring mixer. When forming a pattern in an artificial marble, the first composition, the second composition, and, if necessary, the third or more compositions may be added to each mixer to form various patterns. In this case, the pattern may be varied depending on a type, a content, and an order of the composition in each mixer, and a degree of mixing of the ring mixer.

As another example of the non-uniform mixing, the first composition, the second composition, and, if necessary, the third or more compositions may be mixed using separate mixers, and then remaining compositions other than at least one composition of the first composition, the second composition, and if necessary, the third or more compositions, which are each uniformly mixed, may be directly distributed to the at least one composition. In this case, a pattern can be formed in a desired shape, such as a pattern or base, at a location where the compositions are directly distributed. The distribution refers to a process of dropping and filling one or two or more types of individually mixed compositions into a mold. In this case, each composition is individually mixed before distribution. If necessary, grooves may be formed by an emboss roll, a robot, or the like in order to form a pattern after distribution, and a separate composition may be used to fill the grooves by a robot or the like that fills the mixture. When using the third or more compositions, as these compositions, compositions including the same type of materials as the first composition and/or the second composition may be used, or compositions including at least one component whose hardness is different from the components included in the first composition and/or the second composition may be used.

According to an exemplary embodiment, at least one surface of the artificial marble includes at least two regions among a region provided with the first composition, a region provided with the second composition, and a region where the first composition and the second composition are mixed, and the first inorganic particles of the first composition may be adjusted to be different from the second inorganic particles of the second composition in properties such as hardness and/or the first inorganic powder of the first composition may be adjusted to be different from the second inorganic powder of the second composition in properties such as hardness so that at least one of a surface roughness, a scratch resistance, and a thickness in each of the at least two regions is different. The greater the difference in hardness of the particles or powder, the greater the degree to which the artificial marble is polished under the same conditions, which may lead to a greater difference in roughness. In addition, compared to a case where only powders with different hardnesses are used in the first composition and the second composition, a greater difference in roughness can be realized when particles with different hardnesses are used.

Here, the first inorganic particle, the second inorganic particle, the first inorganic powder, and the second inorganic powder may each be composed of one type of particle or powder, but if they contain two or more types of particles or powders, it also falls within the scope of the present invention. Specifically, any one of the first composition and the second composition, or each of them may include a mixed composition in which two or more types of binder resins, two or more types of inorganic particles, or two or more types of inorganic powders are mixed. For example, when the first inorganic particle and the second inorganic particle is each composed of only one type of particle, all of the second inorganic particles may be different from all of the first inorganic particles in properties such as hardness. As another example, when the first inorganic particles include two or more types of particles, at least one type of particle among the second inorganic particles may be different from at least one type of particle among the first inorganic particles in properties such as hardness. Similarly, all or at least one type of the second inorganic powder may be different from all or at least one type of the first inorganic powder in properties such as hardness.

In addition, when the second inorganic particles include two or more types of particles, the second inorganic particles may include particles having the same properties, such as hardness, as at least one type of the first inorganic particles, but a content of the particles with the same properties may be different in the second inorganic particles and in the first inorganic particles. Similarly, when the second inorganic powder includes two or more types of powders, the second inorganic powder may include powder having the same properties, such as hardness, as at least one type of the first inorganic powder, but a content of the powder with the same properties may be different in the second inorganic powder and in the first inorganic powder. In this case, even if the first composition and the second composition include particles or powders with the same properties, at least one surface of the artificial marble include at least two regions among a region provided with the first composition, a region provided with the second composition, and a region where the first composition and the second composition are mixed, and at least one of a surface roughness, a scratch resistance, and a thickness in each of the at least two regions may be different The difference in content described above may cause differences in an area, a distribution, a thickness, and the like of a portion that is polished when polishing the artificial marble under the same conditions. Specifically, the difference in content between the first inorganic particle and the second inorganic particle may cause a difference in an area, a distribution, or a thickness of a portion that is further polished.

According to an exemplary embodiment, the second inorganic particles may include particles with hardness different from the first inorganic particles, or may include particles with the same hardness as the first inorganic particles in a different content from the first inorganic particles.

When the second inorganic particles include particles with hardness different from the first inorganic particles, all of the second inorganic particles may be different from at least one of the first inorganic particles in hardness, and the second inorganic particles may further include particles with the same hardness as the first inorganic particles. Similarly, when the first inorganic particles include particles with hardness different from the second inorganic particles, all of the first inorganic particles may be different from at least one of the second inorganic particles in hardness, and the first inorganic particles may further include particles with the same hardness as the second inorganic particles.

When the second inorganic particles and the first inorganic particles include particles with the same hardness, all or at least one type of the second inorganic particles may be particles with the same hardness as at least one type of the first inorganic particles, and in this case, a content of the particles with the same hardness among the first and second inorganic particles may be different in the first inorganic particles and in the second inorganic particles.

According to an exemplary embodiment, the second inorganic particles may include particles with a difference in hardness of 1 to 4 from at least one type of the first inorganic particle. For example, the hardness of the first and second inorganic particles may be each 3 to 7.

According to an exemplary embodiment, the first inorganic particles and the second inorganic particles may each include one or more selected from quartz, alumina, aluminum hydroxide, and aluminum. In this case, the hardness may be 7 for quartz, 8 for alumina, 3 for aluminum hydroxide, and 3 for aluminum, respectively.

According to another exemplary embodiment, the second inorganic powder may include powder with hardness different from the first inorganic powder, or may include powder with the same hardness as the first inorganic powder in a different content from the first inorganic powder.

When the second inorganic powder includes powder with hardness different from the first inorganic powder, all of the second inorganic powder may be different from at least one of the first inorganic powder in hardness, and the second inorganic powder may further include powder with the same hardness as the first inorganic powder. Similarly, when the first inorganic powder includes powder with hardness different from the second inorganic powder, all of the first inorganic powder may be different from at least one of the second inorganic powder in hardness, and the first inorganic powder may further include powder with the same hardness as the second inorganic powder.

When the second inorganic powder and the first inorganic powder include powder with the same hardness, all or at least one type of the second inorganic powder may be powder with the same hardness as at least one type of the first inorganic powder, and in this case, a content of the powder with the same hardness among the first and second powders may be different in the first inorganic powder and in the second inorganic powder.

According to an exemplary embodiment, the second inorganic powder may include powder with a difference in hardness of 1 to 4 from at least one type of the first inorganic powder. For example, the hardness of the first and second inorganic powders may be each 3 to 7.

According to an exemplary embodiment, the first inorganic powder and the second inorganic powder may each include one or more selected from quartz, alumina, glass, aluminum hydroxide, fused silica, and aluminum. In this case, the hardness may be 7 for quartz, 8 for alumina, 6.5 for glass, 3 for aluminum hydroxide, 6.5 for fused silica, and 3 for aluminum, respectively. By selecting and using powders with different hardness among the above examples, difference in roughness of the surface of the artificial marble is exhibited as described above, so that the texture of natural stone can be realized.

In the present specification, the difference in surface roughness, scratch resistance, or thickness of at least two regions among the region provided with the first composition, the region provided with the second composition, and the region where the first composition and the second composition are mixed on at least one surface of the artificial marble can be measured in a following manner.

The surface roughness can be measured through a 10-point median roughness, which is a difference between a median height of the five highest peaks and a median depth of the five deepest valleys on a cross-sectional curve of each region. Specifically, a 3 cm reference line was set in two regions with different surface roughness, a thickness was measured with a micrometer at intervals of 0.2 mm, and a ten-point median roughness (height) was calculated. The difference in the 10-point median roughness, measured in this way, of at least two regions among the region provided with the first composition, the region provided with the second composition, and the region where the first composition and the second composition are mixed may be 10 to 250 μm. For example, the 10-point median roughness of the region provided with the first composition and the region provided with the second composition may be 10 to 50 μm and 100 to 250 μm, respectively.

The scratch resistance may be measured by a Scratch hardness test method. Specifically, the scratch resistance may be measured using Scratch Hardness Tester 413, 13196 Diamond tip available from ERICHSEN. The difference in scratch resistance, measured in this way, of at least two regions among the region provided with the first composition, the region provided with the second composition, and the region where the first composition and the second composition are mixed may be greater than 0 N and 0.6 N or less. For example, the scratch resistance of the region provided with the first composition and the region provided with the second composition may be 1.2 to 1.6 N and 0.8 to 1.2 N, respectively.

The thickness refers to a length in a thickness direction perpendicular to a plate surface of the artificial marble and may be measured by a median value of thicknesses at three points spaced 1 cm apart on an arbitrary virtual line with a length of 3 cm on each region. The difference in thickness, measured in this way, of at least two regions among the region provided with the first composition, the region provided with the second composition, and the region where the first composition and the second composition are mixed may be 20 to 400 μm. For example, the respective thicknesses of the region provided with the first composition and the region provided with the second composition may be 19.880 to 20.120 mm and 19.400 to 19.900 mm for a 20T product, and 29.880 to 30.120 mm and 29.400 to 29.900 mm for a 30T product.

According to an exemplary embodiment, the region provided with the first composition and the region provided with the second composition may be a base and a pattern, respectively. According to an exemplary embodiment, the second inorganic particles may include particles with hardness higher than the hardness of the first inorganic particles, or the second inorganic powder may include particles with hardness higher than the hardness of the first inorganic powder. In this case, a surface of a vein pattern has characteristics of greater surface roughness, scratch resistance, and/or thickness compared to a surface of the base. If necessary, the region provided with the second composition and the region provided with the first composition may be a base and a pattern, respectively.

A shape of the base and pattern may be implemented in various ways, and a shape of each region may be determined depending on the pattern implementation method. For example, the shape such as 2-tone, multi-tone, synchronized emboss, gradation, and vein pattern may be implemented, and the vein pattern may be divided into a short vein, a long vein and the like, depending on a length of the vein.

As an example, in an artificial marble including, as a pattern, a short vein whose length is short, when the short vein region is a region including a material with high hardness, a surface of the short vein region may be in a protruding state. Specifically, when the short vein region includes a different type or content of colorant from the base region, only the short vein region with a different color may protrude. The form may vary depending on the shape of the short vein.

As another example, in an artificial marble including, as a pattern, a long vein whose length is long, when the long vein region is a region including a material with low hardness, a thickness of the long vein region may be smaller compared to the base region. The thickness may vary depending on a polished degree of the artificial marble.

As another example, in an artificial marble including, as a pattern, a vein pattern formed by synchronized embossing, when the vein pattern is a region including a material with low hardness, a thickness of the vein pattern may be smaller compared to the base region.

As still another example, in an artificial marble including a multi-tone pattern, regions including materials with different hardness may be evenly distributed, resulting in random thickness differences.

As another example, an artificial marble including a gradation pattern may be implemented by difference in content of particles and/or powders with low hardness. For example, when implementing a gradation pattern by adding a composition including 100 wt % of quartz as inorganic particles to Mixer 1, a composition including 60 wt % of quartz/40 wt % of aluminum hydroxide as inorganic particles to Mixer 2, and a composition including 40 wt % of quartz/60 wt % of aluminum hydroxide to Mixer 3, and distributing the compositions according to positions so as to obtain a desired pattern, after brush polishing under the same conditions, there may be a difference in thickness in order of a region with the composition of Mixer 1 and having the greatest thickness, followed by the region with the composition of Mixer 2 and the region with the composition of Mixer 3. When the respective regions composed of the compositions of Mixer 1, 2, and 3 are made to have colors similar to each other, color gradation can also be implemented.

The first and second inorganic particles may be inorganic particles having a particle size of 0.1 to 4 mm. The particle size may be measured using a particle size analyzer (Beckman Coulter LS 13 320 particle size analyzer).

According to an exemplary embodiment, the first inorganic powder and the second inorganic powder may be inorganic powders having a particle size of 0.1 mm or less, for example, 0.001 mm or greater and 0.1 mm or less. As for the method of measuring a particle size, descriptions related to the inorganic particles can be applied.

According to an exemplary embodiment, the first binder resin and the second binder resin are included in an amount of less than 20 wt % based on 100 wt % of each of the first and second compositions. According to an exemplary embodiment, the first and second binder resins may include 90 wt % or more of unsaturated polyester resin.

Usually, when a content of inorganic substances including inorganic particles, inorganic powder, and the like is 80 wt % or more and a content of the binder resin is less than 20 wt %, it is called ‘E-stone’. When the content of the binder resin is at the level of 30 wt % or more, it is called a ‘solid surface’. Usually, unsaturated polyester (UPE) is often used as the binder resin of ‘E-stone’, but the present invention is not limited thereto and various types of resins such as PMMA are being studied. In addition, as a binder resin for a usual ‘solid surface’, MMA is often used by mixing PMMA polymer and MMA monomer with aluminum hydroxide and curing the mixture, but the present invention is not limited thereto and various resins are being studied. The present invention relates to ‘E-stone’ according to the above definition.

The first and second binder resins may be manufactured by mixing, dispersing, and curing 0.4 to 2.5 parts by weight of a curing agent, 0.05 to 0.3 part by weight of a catalyst, and 0.5 to 7 parts by weight of a coupling agent on the basis of 100 parts by weight of the unsaturated polyester resin, respectively.

The unsaturated polyester resin may include a composition including an unsaturated polyester polymer and a vinylic monomer at a weight ratio of 100:30 to 70, or a cured product thereof. The unsaturated polyester resin may be manufactured using a resin mixture including an unsaturated polyester polymer and a vinylic monomer. Preferably, the unsaturated polyester resin is manufactured using a composition including an unsaturated polyester polymer and a vinylic monomer at a weight ratio of 100:30 to 70. More preferably, the unsaturated polyester resin is manufactured using a composition including 60% by weight to 75% by weight of the unsaturated polyester polymer and 25% by weight to 40% by weight of the vinylic monomer.

The unsaturated polyester resin may be typically a viscous solution in which the unsaturated polyester polymer is diluted in the vinylic monomer. Therefore, when the content of the vinylic monomer is included within the range described above, the viscosity can be reduced, making it easier to manage the unsaturated polyester resin. Furthermore, the vinylic monomer can cure the unsaturated polyester resin from liquid to solid through cross-linking of polyester molecular chains without generating by-products. A weight-average molecular weight of the unsaturated polyester resin is 1,000 to 10,000 g/mol.

The unsaturated polyester polymer is not particularly limited, and examples thereof may include an unsaturated polyester polymer manufactured through a condensation reaction of a saturated or unsaturated dibasic acid and a polyhydric alcohol. Examples of the saturated or unsaturated dibasic acid may include ortho-phthalic acid, isophthalic acid, maleic anhydride, citraconic acid, fumaric acid, itaconic acid, phthalic acid, phthalic anhydride, terephthalic acid, succinic acid, adipic acid, sebacic acid or tetrahydrophthalic acid. In addition, examples of the polyhydric alcohol may include ethylene glycol, diethylene glycol, triethylene glycol, propylene glycol, dipropylene glycol, tripropylene glycol, polypropylene glycol, 1,3-butylene glycol, hydrogenated bisphenol A, trimethylolpropane monoaryl ether, neopentyl glycol, 2,2,4-trimethyl-1,3-pentadiol and/or glycerin. In addition, if necessary, a monobasic acid such as acrylic acid, propionic acid or benzoic acid, or a polybasic acid such as trimellitic acid or tetracarboxylic acid of benzol may be further used.

Examples of the type of vinylic monomer may include an alkyl acrylate monomer or an aromatic vinylic monomer. However, it is preferable to use an aromatic vinylic monomer in consideration of reactivity with the unsaturated polyester polymer. For example, as the aromatic vinylic monomer, one or more selected from the group consisting of styrene, α-methylstyrene, p-methylstyrene, vinyl toluene, alkyl styrene substituted with an alkyl group having 1 to 3 carbon atoms, and styrene substituted with a halogen may be used, and preferably, a styrene monomer may be used.

The curing agent may be included for a curing reaction of the binder, and is not particularly limited as long as a curing agent that is used when manufacturing engineered stone is used. The curing agent may be an organic peroxide-based compound or an azo-based compound. The organic peroxide-based compound may be one or two or more selected from a tert-butyl peroxybenzoate thermal curing agent (TBPB, Trigonox C, akzo nobel), diacyl peroxide, hydroperoxide, ketone peroxide, peroxy ester, peroxy ketal, dialkyl peroxide, alkyl perester, percarbonate, and peroxydicarbonate. For example, the compound may be tert-butyl peroxybenzoate thermal curing agent, benzoyl peroxide, dicumyl peroxide, butyl hydroperoxide, cumyl hydroperoxide, methyl ethyl ketone peroxide, t-butyl peroxy maleic acid, t-butyl hydroperoxide, acetyl peroxide, lauroyl peroxide, t-butyl peroxy neodecanoate, or t-amyl peroxy 2-ethyl hexanoate, but is not necessarily limited thereto.

In addition, the azo-based compound may be azobisisobutyronitrile, but is not necessarily limited thereto. The binder resin may include 0.4 to 2.5 parts by weight of the curing agent on the basis of 100 parts by weight of the unsaturated polyester resin. When the curing agent is included in an amount of 0.4 parts by weight or more, the binder resin can be sufficiently cured, and when the curing agent is included in an amount of 2.5 parts by weight or less, discoloration of the binder can be prevented.

The catalyst may be included for promoting curing of the binder at low temperature, and is not particularly limited as long as a catalyst that is used when manufacturing engineered stone is used. The catalyst may be one or two or more selected from cobalt-based, vanadium-based, or manganese-based metal soaps, tertiary amines, quaternary ammonium salts, and mercaptans. For example, a cobalt 6% catalyst (Hex-Cem, Borchers) may be used. The binder resin may include 0.05 to 0.3 part by weight of the catalyst on the basis of 100 parts by weight of the unsaturated polyester resin. It is advantageous to promote curing when the catalyst is included in an amount of 0.05 parts by weight or more, and discoloration of the binder can be prevented when the catalyst is included in an amount of 0.3 parts by weight or less.

The coupling agent may be included to improve bonding force between the binder resin and inorganic particles such as natural mineral particles, and/or quartz powder, and may be a silane-based or silicate-based coupling agent. The binder resin may include 0.5 to 7 parts by weight of the coupling agent on the basis of 100 parts by weight of the unsaturated polyester resin. It is advantageous to improve bonding force with the inorganic particles and/or quartz powder when the coupling agent is included in an amount of 0.5 parts by weight or more, and it is advantageous to lower the cost of raw materials when it is included in an amount of 7 parts by weight or less.

According to an exemplary embodiment, the first composition and the second composition may each include 500 to 700 parts by weight of the inorganic particles and 200 to 400 parts by weight of the inorganic powder on the basis of 100 parts by weight of the binder resin. In this case, 500 to 700 parts by weight, and preferably 500 to 540 parts by weight, or 550 to 650 parts by weight of the inorganic particles are included on the basis of 100 parts by weight of the binder resin. In this case, 200 to 400 parts by weight, and preferably 200 to 240 parts by weight, or 250 to 350 parts by weight of the inorganic powder is included on the basis of 100 parts by weight of the binder resin.

According to an exemplary embodiment, the first composition and/or the second composition may further include a colorant, such as a pigment, if necessary. A colorant may be included in only one of the first and second compositions, or colorants may be included in both the first and second compositions. If colorants are included in both the first and second compositions, the colorants may be the same or different. The pigment may be included in an amount of 0.01 to 2 parts by weight on the basis of 100 parts by weight of the first composition and/or the second composition. The pigment is not particularly limited as long as it is a pigment that is generally used in the manufacture of artificial marble. For the pigment, an inorganic pigment such as TiO₂, NiO·Sb₂O₃·20TiO₂, Fe₂O₃, Fe₃O₄, or the like may be used.

Another exemplary embodiment of the present invention provides a method for manufacturing an artificial marble, the method including preparing a first composition including a first binder resin, first inorganic particles, and first inorganic powder and a second composition including a second binder resin, second inorganic particles, and second inorganic powder; curing the first composition and the second composition; and finishing surfaces of the cured first and second compositions by a leather finish method. By this method, an artificial marble according to the above-described exemplary embodiments can be manufactured.

First, each of the first and second compositions may be prepared by mixing inorganic particles with a binder resin, mixing the mixture well, and then adding and mixing inorganic powder with the mixture and mixing the mixture well to prepare a composition. At this time, when mixing the inorganic particles with the binder resin, mixing the mixture well, and then adding and mixing the inorganic powder to the mixture and mixing the mixture well to prepare an artificial marble composition, pigments and/or chips of one or more colors may be mixed together to prepare the artificial marble composition. In addition, a first sub-artificial marble composition may be prepared by mixing the inorganic particles with the binder resin, mixing the mixture well, and mixing inorganic powder, a pigment and/or chip with the mixture, a second sub-artificial marble composition may be prepared in the same way while using different types of a pigment and/or chip, and a plurality of, for example, two or more sub-artificial marble compositions may be prepared in a small amount in this way and then mixed to prepare a final artificial marble composition for use. In this case, each of the sub-artificial marble compositions may include different pigments and/or chips, and addition amounts of each of the sub-artificial marble compositions used in the manufacture of the artificial marble may also be different. In addition, when manufacturing the final artificial marble composition by mixing a plurality of sub-artificial marble compositions, the mixing is preferably non-uniformly performed in such a manner that the sub-artificial marble compositions are not completely mixed with each other and the sub-artificial marble compositions remain lumped in places in the final artificial marble composition. Here, each sub-artificial marble composition may correspond to the above-described first composition and second composition.

The step of curing the first composition and the second composition may include putting the first and second compositions into a mold and performing a vacuum vibration compression molding; curing the first and second compositions; and after the curing is completed, cooling the compositions to room temperature (cooling) and removing the compositions from the mold (demolding) to prepare an artificial marble. Specifically, the step may be performed by a vacuum vibration compression molding step in which the first and second compositions are put into a mold and compact-molded using vacuum pressurization equipment, and a step in which the compositions are cured at 90 to 130° C. for 30 minutes to 1 hour, and after the curing is completed, the compositions are cooled to room temperature (cooling) and then removed from the mold (demolding) to prepare an artificial marble.

The step of finishing surfaces of the cured first and second compositions is performed by a leather finish method. The surface finish may also be expressed as polishing. The leather finish method is a method in which a brush pad is used. The surface finish may be performed such that depending on the hardness of each portion of the artificial marble, a portion with strong hardness is polished relatively less and a portion with less strong hardness is polished relatively more.

Unlike the present invention, if the first composition and the second composition do not include particles or powders with different hardness or the content of particles or powders with the same hardness is not made different, even when the surface is finished using a leather finish method, only the same effect as if the entire surface of the artificial marble were matted is exhibited. However, according to the present invention, due to the difference in hardness in each of the regions provided with the first composition and the second composition, a natural texture like natural stone can be realized in each region. A brush pad may be used when finishing the surface. Depending on roughness, brush pads of 36 grit, 46 grit, 60 grit, 120 grit, 220 grit, and 300 grit may be used. Pads with lower level of grits, such as 36 grit to 60 grit, may be used to create surface roughness, and pads with higher levels of grits, such as 120 grit to 300 grit, may be used for a slightly smoother finish.

According to an exemplary embodiment, a step of mixing or patterning the first composition and the second composition may be further included before or during the step of curing the first composition and the second composition. At this time, the mixing may be performed to a relatively lower degree than the degree to which the components of each of the first and second compositions are mixed. For patterning, a patterning method used in the field of artificial marble may be used. For example, the first or second composition may be used to implement a two-tone, multi-tone, vein pattern, gradation, or synchronized emboss pattern.

The mixing or patterning may be performed during or after the step of putting the first and second compositions into the mold and before the vacuum vibration compression step.

The 2-tone pattern may be formed by using two mixers to mix compositions of similar color tones non-uniformly in a ring mixer and then distributing the mixture.

The multi-tone pattern may be formed by preparing three compositions of different colors in three mixers, and then mixing the compositions more uniformly than the 2-tone pattern in a ring mixer so that the mixture of three colors is mixed randomly.

The short vein may be formed by uniformly spraying powder pigment from a mold belt. Powder pigments introduced between the agglomerates of the base composition are revealed when the artificial marble is polished after being cured, forming a short vein. The powder pigments used in this case may include inorganic particles and a pigment.

A long vein with a narrow line width may be formed by molding the base composition, drawing a line on the molded composition with an emboss roll or a robot, and then adding a liquid pigment or powder pigment to the line. A long vein with a wide line width may be formed by molding the base composition, forming a groove in the molded composition with a robot, and then adding a pattern composition to the groove.

Below, Examples will be described in detail to specifically describe the present invention. However, the Examples according to the present invention may be modified in various forms, and the scope of the present invention is not limited to the following Examples. The Examples of the present invention are provided to more completely explain the present invention to one skilled in the art.

### [Method for Preparing Artificial Marble]

(1) The materials of Region A and Region B in Table 1 below were each weighed.

(2) UPE resin and particles (sand) of the material in Region A materials were put into Planetary Mixer A and mixed at 60 rpm for 1 minute, powder was added thereto, and the mixture was mixed at the same rpm for 2 minutes. The materials in Region B were also mixed in Planetary mixer B in the same manner.

(3) In Examples 3 to 5 and Comparative Example 1, the mixture of the materials in Region A and Region B was put into Planetary mixer A, rotated 5 times at a speed of 20 rpm, mixed non-uniformly, and then distributed into a mold. In Examples 1 and 2, the base and the vein region were separated by a partition without non-uniform mixing, and the mixture in Region A was distributed to the base region and the mixture in Region B was distributed to the vein region in the mold.

(4) In the vacuum vibration compression equipment, vibration was applied at 2500 rpm for 15 seconds and at 2900 rpm for 45 seconds under the conditions of vacuum of 5 mbar and pressure of 2.5 bar, and then the mold was subjected to the curing for 30 minutes at 130° C. of the upper plate and 130° C. of the lower plate.

(5) The leather finish process was performed using a brush pad. The polishing was performed from a rough pad (with low grit or water resistance) to a soft pad. Specifically, the polishing was performed using Filiflex and Airflex Antiquing Brush available from Tenex, for example, 36 grit diamond brush, 36 grit Filiflex, 46 grit Filiflex, 60 grit Filiflex, 120 grit Airflex, 220 grit Airflex, and 300 grit Airflex. The rpm and pressure of the polishing machine were 750 rpm and ½ bar, respectively.

### [Evaluation Method]

### A. 10-Point Median Roughness

For the surface roughness, a 3 cm reference line was set in two regions with different surface roughness, a thickness was measured with a micrometer at intervals of 0.2 mm, and a 10-point median roughness (height) was calculated.

### B. Scratch Resistance Test

The scratch resistance was measured using Scratch Hardness Tester 413, 13196 Diamond tip available from ERICHSEN.

### C. Thickness Difference

A median value of the thicknesses at three points spaced 1 cm apart on a virtual line with a length of 3 cm was measured.

TABLE 1

| | | | 10-point | | |
|---|---|---|---|---|---|
| | | | median | | |
| | | | roughness | Scratch | Thickness |
| | | | (height) | resistance | difference |
| | Region A | Region B | (μm) | (N) | (μm) |
| Example 1 | UPE 12 | UPE 12 | Region A: | Region A: | 100 |
| | wt %, | wt %, | 25 | 1.4 | |
| | Quartz | Quartz | Region B: | Region B: | |
| | particles | particles | 28 | 1.5 | |
| | 60 wt %, | 60 wt %, | | | |
| | Quartz | Alumina | | | |
| | powder 28 | powder 28 | | | |
| | wt % | wt % | | | |
| Example 2 | UPE 12 | UPE 12 | Region A: | Region A | 400 |
| | wt %, | wt %, | 25 | (1.4N) | |
| | Quartz | Quartz | Region B: | Region B | |
| | particles | particles | 100 | (0.9N) | |
| | 60 wt %, | 18 wt %, | | | |
| | Quartz | Quartz | | | |
| | powder 28 | powder | | | |
| | wt % | 8.4 wt %, | | | |
| | | Aluminum | | | |
| | | particles | | | |
| | | 42 wt %, | | | |
| | | Aluminum | | | |
| | | powder | | | |
| | | 19.6% | | | |
| Example 3 | UPE 12 | UPE 12 | Region A: | Region A | 350 |
| | wt %, | wt %, | 25 | (1.4N) | |
| | Quartz | Aluminum | Region B: | Region B | |
| | particles | particles | 140 | (1.0N) | |
| | 60 wt %, | 60 wt %, | | | |
| | Quartz | Quartz | | | |
| | powder 28 | powder 28 | | | |
| | wt % | wt % | | | |
| Example 4 | UPE 12 | UPE 12 | Region A: | Region A | 220 |
| | wt %, | wt %, | 25 | (1.4N) | |
| | Quartz | Quartz | Region B: | Region B | |
| | particles | particles | 110 | (1.1N) | |
| | 60 wt %, | 32 wt %, | | | |
| | Quartz | ATH | | | |
| | powder 28 | particles | | | |
| | wt % | 28%, | | | |
| | | Quartz | | | |
| | | powder 28 | | | |
| | | wt % | | | |
| Example 5 | UPE 12 | UPE 12 | Region A: | Region A | 280 |
| | wt %, | wt %, | 25 | (1.4N) | |
| | Quartz | Quartz | Region B: | Region B | |
| | particles | particles | 30 | (0.9N) | |
| | 60 wt %, | 60 wt %, | | | |
| | Quartz | ATH | | | |
| | powder 28 | powder 28 | | | |
| | wt % | wt % | | | |
| Comparative | UPE 12 | UPE 12%, | Region A: | Region A | 0 |
| Example 1 | wt %, | Quartz | 25 | (1.4N) | |
| | Quartz | particles | Region B: | Region B | |
| | particles | 60 wt %, | 25 | (1.4N) | |
| | 60 wt %, | Quartz | | | |
| | Quartz | powder 28 | | | |
| | powder 28 | wt % | | | |
| | wt % | | | | |

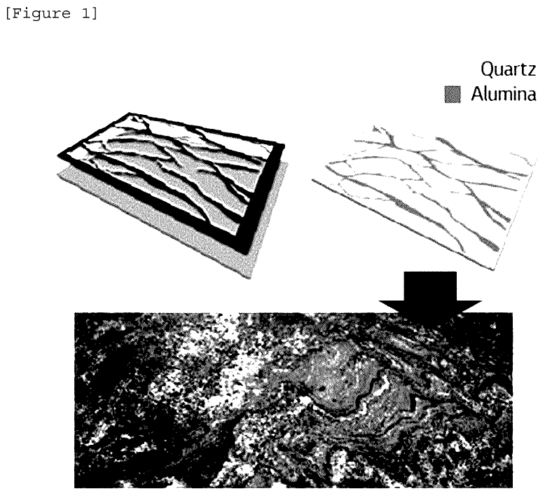

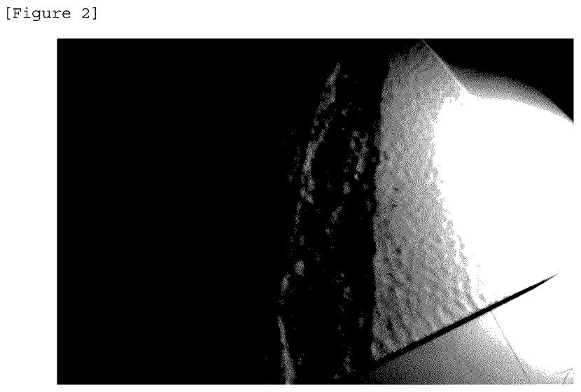

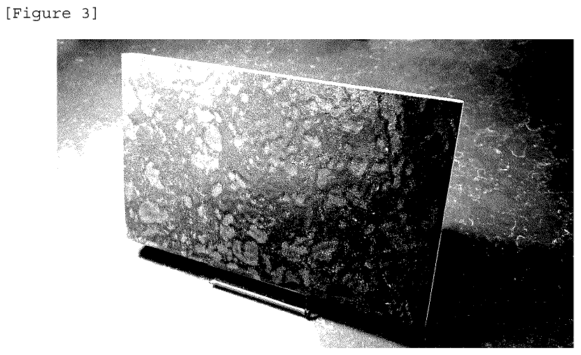

In Comparative Example 1, the same composition was used in Region A and Region B, so that the 10-point median roughness and the scratch resistance in Regions A and B were the same. However, in Examples 1 and 5 where inorganic powder with low hardness was included in Region B compared to Region A, in Examples 3 and 4 where inorganic particles with low hardness were included in Region B compared to Region A, and in Example 2 where inorganic particles and inorganic powder with low hardness were included in Region B compared to Region A, the 10-point median roughness, the scratch resistance, and the thickness were different between Regions A and B, resulting in a texture close to natural stone. Photographs of the surfaces of the artificial marbles prepared in Examples 1 to 3 are shown in FIGS. 1 to 3, respectively.

1. An artificial marble comprising:
a first composition comprising a first binder resin, a first inorganic particle, and first inorganic powder; and
a second composition comprising a second binder resin, a second inorganic particle, and second inorganic powder,
wherein at least one surface of the artificial marble comprises at least two regions among a region provided with the first composition, a region provided with the second composition, and a region where the first composition and the second composition are mixed, and at least one of a surface roughness, a scratch resistance, and a thickness in each of the at least two regions is different.

2. The artificial marble of claim 1, wherein the first composition and the second composition each comprise a mixed composition in which two or more types of binder resins, two or more types of inorganic particles, or two or more types of inorganic powders are mixed.

3. The artificial marble of claim 1, wherein the second inorganic particle comprises a particle with hardness different from the first inorganic particle, or comprises a particle with the same hardness as the first inorganic particle in a different content from the first inorganic particle.

4. The artificial marble of claim 3, wherein the second inorganic particle comprises a particle with different hardness from the first inorganic particle and a particle with the same hardness as the first inorganic particle, or wherein the first inorganic particle comprises a particle with different hardness from the second inorganic particle and a particle with the same hardness as the second inorganic particle.

5. (canceled)

6. The artificial marble of claim 1, wherein the second inorganic powder comprises powder with different hardness from the first inorganic powder, or comprises powder with the same hardness as the first inorganic powder in a different content from the first inorganic powder.

7. The artificial marble of claim 6, wherein the second inorganic powder comprises powder with different hardness from the first inorganic powder and powder with the same hardness as the first inorganic powder, or wherein the first inorganic powder comprises powder with different hardness from the second inorganic powder and powder with the same hardness as the second inorganic powder.

8. (canceled)

9. The artificial marble of claim 1, wherein a degree of mixing of the components included in the first composition and a degree of mixing of the components included in the second composition are each higher than a degree of mixing of the first composition and the second composition.

10. The artificial marble of claim 1, wherein the components included in the first composition are in a uniformly mixed state, the components included in the second composition are in a uniformly mixed state, and the first composition and the second composition are in a state in which they are non-uniformly mixed with each other.

11. The artificial marble of claim 3, wherein the second inorganic particle comprises an inorganic particle with a difference in hardness of 1 to 4 from the first inorganic particle.

12. The artificial marble of claim 3, wherein the hardness of the first and second inorganic particles is each 3 to 7.

13. The artificial marble of claim 3, wherein the first inorganic particle and the second inorganic particle each comprise one or more selected from quartz, alumina, aluminum hydroxide, and aluminum.

14. The artificial marble of claim 6, wherein the second inorganic powder comprises powder with a difference in hardness of 1 to 4 from the first inorganic powder.

15. The artificial marble of claim 6, wherein the hardness of the first and second inorganic powder is each 3 to 7.

16. The artificial marble of claim 6, wherein the first inorganic powder and the second inorganic powder each comprise one or more selected from quartz, alumina, glass, aluminum hydroxide, fused silica, and aluminum.

17. The artificial marble of claim 1, wherein the first binder resin and the second binder resin are the same or different from each other and each comprise 90 wt % or more of an unsaturated polyester resin, and the unsaturated polyester resin comprises a composition comprising an unsaturated polyester polymer and a vinylic monomer at a weight ratio of 100:30 to 70, or a cured product thereof.

18. The artificial marble of claim 1, wherein the first composition and the second composition each comprise 500 to 700 parts by weight of the inorganic particle and 200 to 400 parts by weight of the inorganic powder on the basis of 100 parts by weight of the binder resin.

19. The artificial marble of claim 1, wherein the region provided with the first composition and the region provided with the second composition are a base and a pattern, respectively.

20. A method for manufacturing the artificial marble of claim 1, the method comprising:
preparing a first composition comprising a first binder resin, a first inorganic particle, and first inorganic powder, and a second composition comprising a second binder resin, a second inorganic particle, and second inorganic powder;
curing the first composition and the second composition; and
finishing surfaces of the cured first and second compositions by a leather finish method,
wherein at least one surface of the artificial marble comprises at least two regions among a region provided with the first composition, a region provided with the second composition, and a region where the first composition and the second composition are mixed, and at least one of a surface roughness, a scratch resistance, and a thickness in each of the at least two regions is different.

21. The method of claim 20, further comprising mixing or patterning the first composition and the second composition before or during the curing the first composition and the second composition.

22. The method of claim 20, wherein the leather finish method is performed using a wire brush.
